(19) United States
(12) Patent Application Publication
(10) Pub. No.: US 2008/0143142 A1
(43) Pub. Date: Jun. 19, 2008

(54) Trailer With Double Wall Extruded Panel Nose Construction

(75) Inventor: Brian C. Lemmons, Katy, TX (US)

Correspondence Address: SMITH IP SERVICES, P.C., P.O. Box 997, Rockwall, TX, 75087, US

(73) Assignee: Vantage Trailers, Inc.

(21) Appl. No.: 11/566,091

(22) Filed: Dec. 1, 2006

(51) Int. Cl. B62D 25/02

(52) U.S. Cl. 296/186.1

(57) ABSTRACT

A trailer having a double wall extruded panel nose construction. A trailer wall construction for use as part of a trailer assembly includes a curved front wall including at least one curved panel having spaced apart inner and outer shells. Another trailer wall construction includes a series of elongated panels joined to each other along respective adjacent edges, each of the panels being curved and having spaced apart inner and outer shells. The joined panels form a curved wall of the trailer assembly.

### BACKGROUND

The present invention relates generally to wheeled vehicle construction and, in an embodiment described herein, more particularly provides a trailer having a double wall extruded panel nose construction.

It is very beneficial to be able to reduce the tare weight of a trailer used commercially to haul loads. For example, bridge laws and other regulations limit the gross weight of over-the-road vehicles. Thus, if the tare weight can be reduced, the weight of cargo can be increased, thereby resulting in more efficient and economical hauling operations.

Where a trailer is used to haul loose material, such as dirt, garbage, etc., it would be beneficial to provide a trailer wall construction which minimizes or eliminates square corners between the walls. This would prevent the loose material from being retained in the corners when the trailer load is dumped. Particularly in very cold conditions, damp material is prone to freezing and sticking in the front of conventional trailers.

Since fuel costs reduce profit margins in the material transfer industry, aerodynamic trailer designs would be very beneficial.

Another important consideration in trailer construction is aesthetics. It would be beneficial to be able to provide a trailer wall construction which is aesthetically pleasing, both at the time it is manufactured and after it has been in use.

Unfortunately, typical trailer wall construction methods have been unable to adequately satisfy the needs for reduced weight, minimized square corners between walls, reduced freezing of materials, improved aerodynamics and improved aesthetics. Thus, it will be appreciated that a need exists for improved trailer wall construction.

### SUMMARY

In carrying out the principles of the present invention, a trailer wall construction is provided which solves at least one problem in the art. One example is described below in which a trailer assembly includes a curved wall made up of curved extruded hollow panels. Another example is described below in which the panels are uniquely joined to each other, and to other walls in the trailer assembly.

In one aspect of the invention, a trailer wall construction for use as part of a trailer assembly is provided. The trailer wall construction includes a curved front wall including at least one curved panel having spaced apart inner and outer shells.

In another aspect of the invention, a trailer wall construction for use in a trailer assembly includes a series of elongated panels joined to each other along respective adjacent edges. Each of the panels is curved and has spaced apart inner and outer shells. The joined panels form a curved wall of the trailer assembly.

These and other features, advantages, benefits and objects of the present invention will become apparent to one of ordinary skill in the art upon careful consideration of the detailed description of representative embodiments of the invention hereinbelow and the accompanying drawings, in which similar elements are indicated in the various figures using the same reference numbers.

### BRIEF DESCRIPTION OF THE DRAWINGS

FIG. 1 is an isometric view of a trailer assembly embodying principles of the present invention;

FIG. 2 is an enlarged scale top plan view of a nose portion of the trailer assembly of FIG. 1;

FIG. 3 is a further enlarged scale top plan view of an extruded panel section of the trailer nose portion;

FIG. 4 is a further enlarged scale top plan view of an engagement portion of the extruded panel section; and

FIG. 5 is a top plan view of another engagement portion of the extruded panel section.

### DETAILED DESCRIPTION

It is to be understood that the various embodiments of the present invention described herein may be utilized in various orientations, such as inclined, inverted, horizontal, vertical, etc., and in various configurations, without departing from the principles of the present invention. The embodiments are described merely as examples of useful applications of the principles of the invention, which is not limited to any specific details of these embodiments.

In the following description of the representative embodiments of the invention, directional terms, such as “above”, “below”, “upper”, “lower”, etc., are used for convenience in referring to the accompanying drawings.

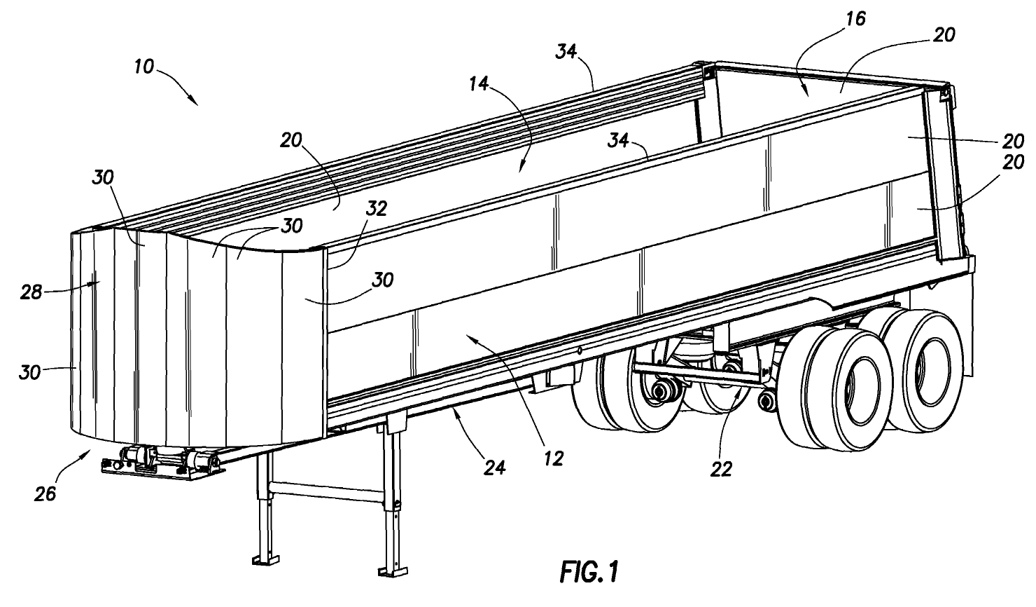

Representatively illustrated in FIG. 1 is a trailer assembly 10 which embodies principles of the present invention. The trailer assembly 10 is representatively illustrated as being of the type known as a dump trailer, but it should be clearly understood that other types of trailers (such as box trailers, etc.) can incorporate principles of the invention.

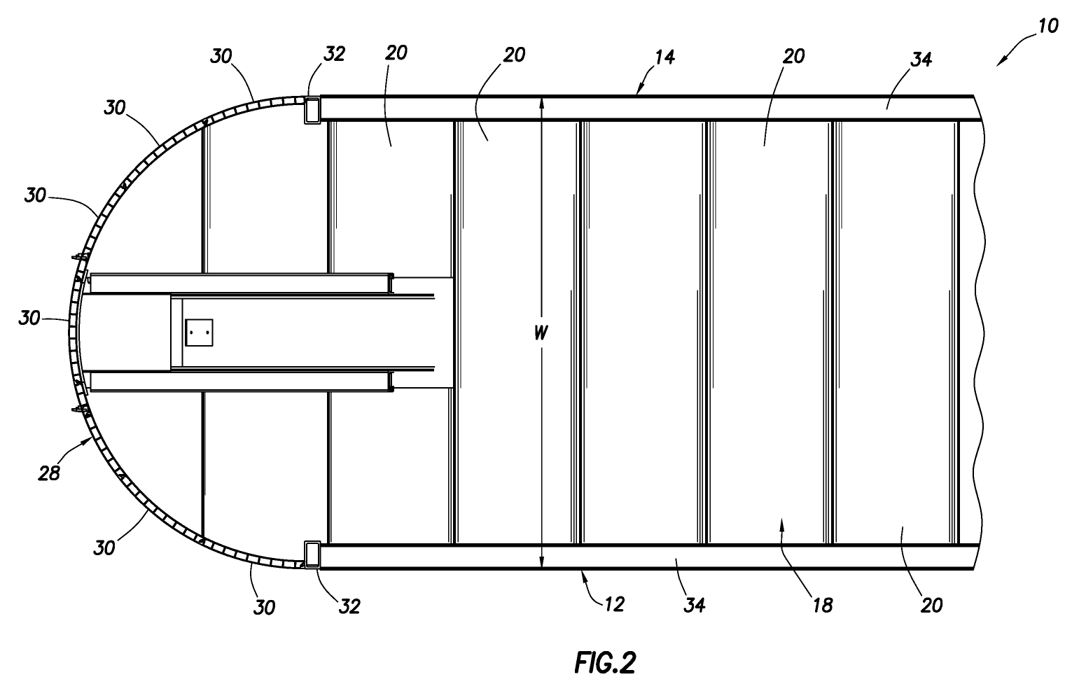

The trailer assembly 10 includes vertical side walls 12, 14 which are preferably constructed in a manner described in either of U.S. patent application Ser. Nos. 11/112,489 and 11/223,581, the entire disclosures of which are incorporated herein by this reference. A tailgate 16 and floor 18 (see FIG. 2) may also be constructed using the techniques described in the incorporated patent applications.

Preferably, the side walls 12, 14, tailgate 16 and floor 18 are made up of joined hollow extruded panels 20, each of which has spaced apart inner and outer shells with hollow cavities therebetween, as described in the incorporated patent applications. However, it should be clearly understood that other types of walls, panels, etc., may be used in keeping with the principles of the invention.

A suspension system 22 supports a rear end of the trailer assembly 10 above a road surface. The suspension system 22 and associated undercarriage 24 may be similar to those described in U.S. patent application Ser. No. 11/176,037, the entire disclosure of which is incorporated herein by this reference. However, other types of suspension systems and undercarriages may be used in keeping with the principles of the invention.

In one unique feature of the trailer assembly 10, a nose portion 26 of the trailer assembly includes a generally vertical front wall 28 which has a curved shape. Preferably, the front wall 28 is made up of multiple curved panels 30. In FIG. 2, the curved shape of the front wall 28 and each of the panels 30 can be clearly seen.

Note that the front wall 28 in this example has a semicircular shape and extends in a circular arc between the side walls 12, 14. Each of the panels 30 comprises a section of the circular arc, and the joined panels thereby make up the semicircular shape of the front wall 28. However, it should be clearly understood that other curved shapes (such as oval, elliptical, etc.) may be used in keeping with the principles of the invention.

Each of the panels 30 is elongated and extends in a vertical direction. Thus, joined edges between respective adjacent panels also extend in a vertical direction. However, it should be clearly understood that the panels 30 and respective adjacent edges could extend in other directions (such as horizontal or inclined, etc.), in keeping with the principles of the invention.

As depicted in FIGS. 1 & 2, the front wall 28 is made up of seven of the panels 30. The panels 30 are preferably of equal width, therefore, each panel makes up approximately 25.7° of the 180° circular arc of the front wall 28. However, any number of the panels 30 could be used, and it is not necessary for the panels to have equal widths, in keeping with the principles of the invention.

Note that the panels 30 at each end of the front wall 28 are attached both to the floor 18 and to a respective one of the side walls 12, 14. Vertical posts 32 facilitate the attachment between the panels 30 and the side walls 12, 14. However, if the panels 20 in the side walls 12, 14 extend vertically, then the panels 20, 30 in the front and side walls 12, 14, 28 could be joined to each other along respective adjacent edges, without use of the posts 32, if desired.

Although in FIGS. 1 & 2 a top rail is not illustrated on the front wall 28 (similar to the top rails 34 on the side walls 12, 14), such a top rail could be provided, if desired. Furthermore, additional or alternate components, such as bottom rails, connectors, etc. suitable for use with hollow extruded panels (for example, the various components described in the incorporated patent applications) may be used, if desired.

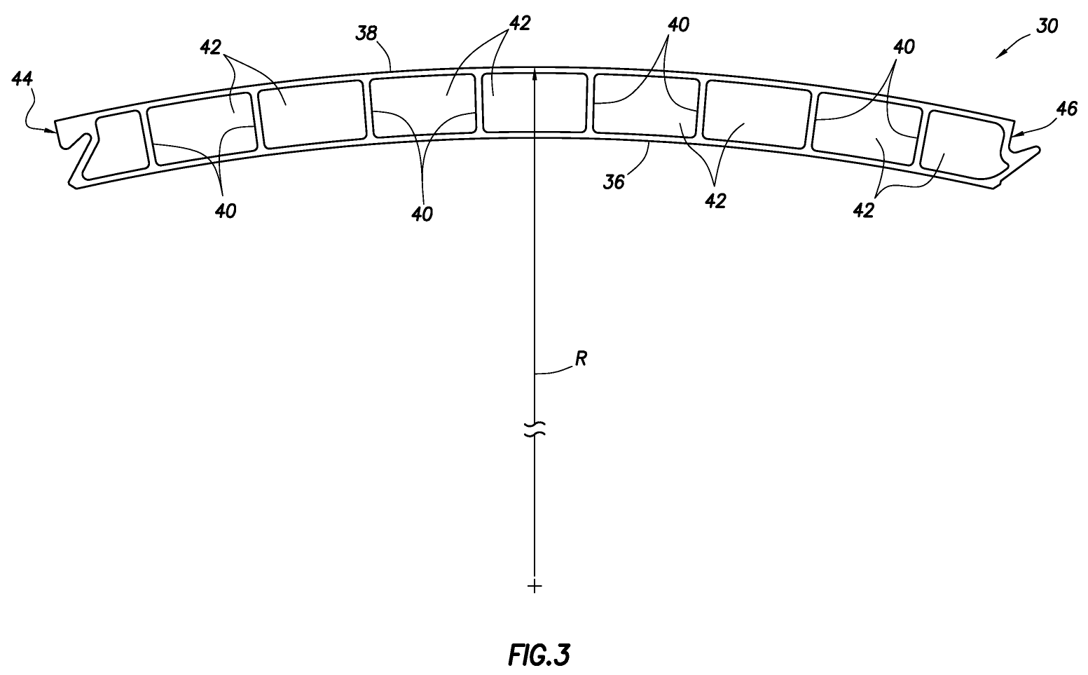

Referring additionally now to FIG. 3, an enlarged top view of one of the panels 30 is representatively illustrated, apart from the remainder of the trailer assembly 10. In this view it may be seen that the panel 30 has a radius R which is preferably approximately one-half of the width W (see FIG. 2) of the trailer assembly 10, which is also the lateral width of the front wall 28. For example, if the front wall 28 has a width W of 90 inches, then the radius R of each panel is preferably 45 inches, although as described above, other curvatures may be used in keeping with the principles of the invention.

In this enlarged view of the panel 30, the construction of the panel may also be seen more clearly. The panel 30 is preferably constructed with an inner shell 36 spaced apart from an outer shell 38, with multiple webs 40 connecting the shells to each other.

The webs 40 separate multiple internal hollow cavities 42. It is not necessary for the cavities 42 to be hollow, since they could instead be filled with substances, such as foam, plastics, etc. to further strengthen the panel 30.

Although the inner shell 36 is depicted in FIG. 3 as having approximately the same thickness as the outer shell 38, these shells could have different thicknesses, if desired. For example, the inner shell 36 could be made thicker to provide increased wear resistance, puncture resistance and strength.

An engagement portion 44 is formed on a side edge of the panel 30, and a complementarily shaped engagement portion 46 is formed on an opposite side edge. These engagement portions 44, 46 are constructed to facilitate convenient and durable joining of the respective adjacent edges of the panels 30 in the front wall 28.

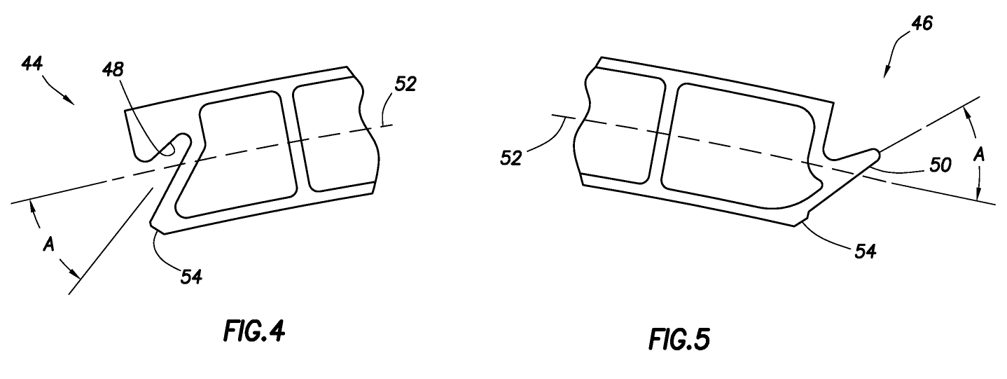

An enlarged scale view of the engagement portion 44 is representatively illustrated in FIG. 4. In this view it may be seen that the engagement portion 44 includes a recess 48 which is laterally inclined at an angle A relative to an axis of curvature 52 of the panel 30.

An enlarged scale view of the engagement portion 46 is representatively illustrated in FIG. 5. In this view it may be seen that the engagement portion 46 includes a projection 50 which is laterally inclined at the same angle A relative to the axis of curvature 52 of the panel 30.

The recess 48 and projection 50 are complementarily shaped so that, when the engagement portions 44, 46 of adjacent panels 30 are engaged with each other, the respective adjacent edges of the panels may be readily and securely joined. The inclined angles A of the projections 50 and recesses 48 facilitate assembly of the panels 30 in the semicircular shape of the front wall 28. However, it should be clearly understood that other types of engagement portions (such as those described in the incorporated patent applications) may be used in keeping with the principles of the invention.

At each of the attachments between adjacent edges of the panels 30, the panels are preferably welded to each other along their respective edges. However, it should be clearly understood that other attachment methods may be used instead of, or in addition to, welding. For example, adhesive bonding, mechanical fasteners, or any other type of attachment method or combination of attachment methods may be used, as well as any of the methods described in the incorporated patent applications.

Preferably, the edges of the panels 30 are attached by welding along inner seams between the adjacent edges. Chamfers 54 formed on the engagement portions 44, 46 facilitate the welding along the inner seams. The edges of the panels 30 could also (or alternatively) be attached by welding along outer seams between the adjacent edges. Chamfers similar to the chamfers 54 shown in FIGS. 4 & 5 could be provided on the engagement portions 44, 46 to facilitate this welding along the outer seams.

It may now be fully appreciated that the trailer wall construction described above provides several benefits. For example, the use of square corners between the front wall 28 and the side walls 12, 14 is eliminated. The construction of the front wall 28 is aesthetically pleasing, and the spaced apart inner and outer shells 36, 38 ensure that it is less likely that material or items carried in the trailer assembly 10 will puncture or deform the exterior of the front wall. The hollow cavities 42 with supporting webs 40 in each of the panels 30 provide enhanced strength while also providing a light weight construction. The cavities 42 also provide insulation, thereby helping to prevent material carried in the trailer assembly 10 from freezing. Furthermore, the curved shape of the front wall 28 and its smooth joining to the side walls 12, 14 without square corners improves the aerodynamics of the trailer assembly 10.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention. Accordingly, the foregoing detailed description is to be clearly understood as being given by way of illustration and example only, the spirit and scope of the present invention being limited solely by the appended claims and their equivalents.

What is claimed is:

1. A trailer wall construction for use as part of a trailer assembly, the trailer wall construction comprising:
a curved front wall including at least one curved panel having spaced apart inner and outer shells.

2. The trailer wall construction of claim 1, wherein the front wall includes a plurality of the curved panels.

3. The trailer wall construction of claim 2, wherein adjacent edges of the curved panels are welded together on an inner side of the front wall.

4. The trailer wall construction of claim 2, wherein adjacent edges of the curved panels are welded together on an outer side of the front wall.

5. The trailer wall construction of claim 2, wherein adjacent edges of the curved panels are adhesively bonded to each other.

6. The trailer wall construction of claim 2, wherein adjacent edges of the curved panels include respective first and second engagement portions, the first engagement portion having a recess formed thereon, and the second engagement portion having a projection formed thereon, whereby the projection and recess are complementarily shaped for engagement with each other.

7. The trailer wall construction of claim 6, wherein each of the projection and recess is laterally inclined relative to a curvature of the curved panels.

8. The trailer wall construction of claim 1, wherein the front wall has a lateral width, and wherein a radius of curvature of the curved panel is approximately one-half of the front wall width.

9. The trailer wall construction of claim 1, wherein the curved panel includes at least one hollow cavity between the inner and outer shells.

10. A trailer wall construction for use in a trailer assembly, the trailer wall construction comprising:
a series of elongated panels joined to each other along respective adjacent edges, each of the panels being curved and having spaced apart inner and outer shells, and
wherein the joined panels form a curved wall of the trailer assembly.

11. The trailer wall construction of claim 10, wherein the wall is a front wall of the trailer assembly.

12. The trailer wall construction of claim 10, wherein each of the panels is generally vertically oriented in the curved wall.

13. The trailer wall construction of claim 10, wherein the respective adjacent edges of the curved panels are welded together on an inner side of the wall.

14. The trailer wall construction of claim 10, wherein the respective adjacent edges of the curved panels are welded together on an outer side of the front wall.

15. The trailer wall construction of claim 10, wherein the respective adjacent edges of the curved panels are adhesively bonded to each other.

16. The trailer wall construction of claim 10, wherein the respective adjacent edges of the curved panels include respective first and second engagement portions, the first engagement portion having a recess formed thereon, and the second engagement portion having a projection formed thereon, whereby the projection and recess are complementarily shaped for engagement with each other.

17. The trailer wall construction of claim 16, wherein each of the projection and recess is laterally inclined relative to a curvature of the curved panels.

18. The trailer wall construction of claim 10, wherein the wall has a lateral width, and wherein a radius of curvature of the curved panel is approximately one-half of the wall width.

19. The trailer wall construction of claim 10, wherein the curved panel includes at least one hollow cavity between the inner and outer shells.

20. The trailer wall construction of claim 10, wherein at least one of the curved panels is joined to two other walls of the trailer assembly, each of the two other walls including at least one panel having spaced apart inner and outer shells.
